(19) United States
(12) Patent Application Publication
(10) Pub. No.: US 2012/0308896 A1
(43) Pub. Date: Dec. 6, 2012

(54) POSITIVE-ELECTRODE MATERIAL FOR SECONDARY BATTERY AND SECONDARY BATTERY USING THE SAME

(76) Inventor: Yusuke Asari, Sakado (JP)

(21) Appl. No.: 13/513,267

(22) PCT Filed: Jun. 3, 2011
(86) PCT No.: PCT/JP2011/062838

§ 371 Date: Jun. 1, 2012

(51) Int. Cl. H01M 4/58

(52) U.S. Cl. 429/231.95; 429/218.1; 252/182.1

(57) ABSTRACT

The present invention has an object of providing a positive-electrode material for a non-aqueous electrolyte secondary battery having a 2− or higher dimensional lithium diffusion network structure of high lithium capacity, containing phosphoric acid of high thermal stability, and having lithium ions in which the ratio of the charge, compensation center and lithium ions exceeds 1:2. That is, a positive-electrode material for a secondary battery comprising a compound represented by the general formula A₄₋ₓM(PO₄)₂, and an electrode and a battery containing the same are provided. In the formula, M represents a transition metal (preferably, at least one member selected from the group consisting of Sc, Ti, V, Cr, Mn, Fe, Co, Ni, Cu, and Zn), A represents at least one of elements selected from alkali metals including Li, Na and K, and X represents 0≦X≦4.

### TECHNICAL FIELD

The present invention concerns a positive-electrode material for a secondary battery (rechargeable battery) and a secondary battery using the same and it particularly relates to a positive-electrode material for a lithium ion secondary battery.

### BACKGROUND ART

In a non-aqueous electrolyte secondary battery using alkali metals such as lithium and sodium, alkaline earth metals such as magnesium, or alloys and compounds thereof as a negative-electrode active material, electric capacity and charge reversibility are ensured by insertion or intercalation of negative-electrode metal ions into a positive-electrode active material. The electric capacity of the positive-electrode material generally tends to be lower than the electric capacity of the negative-electrode. For reducing size and weight of lithium ion batteries in the future, there is a major subject to develop a positive material of a larger capacity than usual.

For active material as the positive-electrode material of the secondary battery using lithium as the negative-electrode active material proposed in the past, battery using a layered rock-salt type metal oxides LiMO₂, spinel type metal oxide LiMn₂O₄ (for example, refer to Patent Literature 1), olivine type compound LiMPO₄ (for example, refer to Non-Patent Literature 1), pyrophosphoric acid compound Li₂MP₂O₇ (for example, Non-Patent Literature 2), etc. as the positive-electrode material have been proposed. The electric capacity of the positive-electrode material is to be described below.

Layered rock-salt type oxides LiMO₂ have been generally utilized and investigated as a standard positive-lectrode active material for the lithium ion battery. Typically, M=Co, Mn, Ni, or a mixture thereof. They belong to the space group R-3m (No. 166) and are customarily referred to as an α-NaFeO₂ structure. It has a layer-by-layer structure of transition metal layers and lithium layers in which lithium is present only in the lithium layer. When all lithium atoms are deintercalated, the lithium layers are eliminated and the crystal structure is collapsed. Accordingly, for maintaining the crystal structure, the maximum lithium utilization rate remains at about 0.5. In the practical material where M=Co(LiCoO₂), practical capacity is 120 to 140 mAh/g due to 0.5 electronic reaction. A material where M=Mn is advantageous in view of low cost but its practical use is difficult in view of the problem of potential fall and degradation of capacity. While a material where M=Ni is advantageous in view of high potential and low cost, it has not yet been put to practical use because of low thermal resistance and degradation of capacity. Composite material includes ternary transition metal layered positive-electrode (LiNi_{1/3}Mn_{1/3}CO_{1/3}O₂) and NiMn positive-electrode (LiNi_{1/ 2}Mn_{1/2}O₂). While the ternary transition metal layered positive-electrode has a charge capacity of 145 to 200 mAh/g, no further improvement in the performance is difficult for the layered rock-salt type structure.

A spinel oxide LiMn₂O₄ is stable in the crystal structure and excellent in the stability during over charge compared with the layered metal oxide. Further, it is excellent in the conductivity and advantageous in view of the life characteristic. However, the ratio of lithium in the chemical composition is small and manganese and oxygen occupy most of the weight therein. Therefore, the spinel oxide has a practical capacity as low as 100 mAh/g or less, which is inferior to that of other positive-electrode materials. Further, in the spinel oxide, manganese may possibly be leached into the electrolyte during storage at high temperature, the leached manganese may clog a separator or cause film deposition on the negative-electrode to increase the battery resistance and deteriorate the active material (refer to Patent Literature 1). It is considered that manganese is leached out because trivalent manganese has a Jahn-Teller effect (quantum mechanical effect of stabilizing energy by spontaneously distorting the symmetricity). Trivalent manganese, when becomes unstable in view of energy, forms more stable bivalent manganese and tetravalent manganese, and bivalent manganese is leached out as ions. It is considered that the electric capacity is further lowered along with such leaching of manganese.

The olivinic acid compound LiMPO₄ is known as one of a group of a series of positive-electrode active materials represented by polyanion (chemical formula: (XO₄)y⁻). In the chemical formula LiMPO₄, M=Fe, Mn, Co, Ni, etc. Among them, an olivine type lithium iron phosphate (LiₓFePO₄, 0≦x≦1; referred to hereinafter as olivine Fe) was found in 1997 by J. B. Goodenough, et al (Texas University, US) and its practical usefulness was demonstrated subsequently in the report of A. Yamada (Tokyo University), et al. for charge-discharge characteristic substantially reproducing the theoretical capacity and, from since, subsequent studies have been promoted. The olivine type LiFePO₄ contains one lithium atom per chemical formula and has a capacity of 160 mAh/g (refer to Non-Patent Literature 1). However, the voltage (open circuit voltage) is 3.4 V and has a drawback that the working potential is lower than that of existent layered cobalt oxide positive-electrodes (4.0 V).

Pyrophosphoric acid compound Li₂MP₂O₇ (refer to Non-Patent Literature 2) is a positive-electrode active material using Fe, Mn, Co, etc. for M. It was synthesized for the material where M=Mn in 2006 but charge-discharge is substantially impossible. First charge-discharge experiment was measured for M=Fe in 2010. Charge-discharge characteristic for M=Fe is superior to that for M=Mn and the actual electric capacity reaches 80 to 110 mAh/g. However, the value is for the capacity corresponding to 1 electron reaction and means that only one lithium ion can be utilized in the chemical formula Li₂MP₂O₇. The theoretical electric capacity is 220 mAh/g providing that all of lithium ions in the pyrophosphoric acid compound could be utilized for charge-discharge.

In view of the matters described above electric capacity is to be summarized. The electric capacity of the metal oxide positive-electrode is within a range from 100 to 200 mAh/g. The electric capacity of the phosphoric acid type positive-electrode is within a range from 110 to 220 mAh/g. Generally, the electric capacity increases more as the mass ratio of lithium ions is higher based on the entire mass shown by the chemical formula. As the electric capacity increases, the size and the weight of the lithium ion battery can be decreased more. Accordingly, it is essential to increase the ratio of the lithium ions in the positive-electrode material in the development of the positive-electrode material.

Then, thermal stability is to be discussed. It is generally known that most of crystal defects in metal oxides are depletion of oxygen. When the oxygen depletion occurs, the deintercalated oxygen may possibly be released to the outside of the positive-electrode. In this case, when the temperature is high, oxygen may possibly react with the non-aqueous electrolyte, etc. Accordingly, it is a major factor for the lithium ion battery to ensure the thermal stability.

It is known that among the metal oxide positive-electrodes, LiCoO₂ causes self heat generation due to structural instability upon overcharge to generate thermal decomposing reaction by deintercalation of oxygen at a temperature of 200° C. or higher. In the layered ternary positive-electrode (LiNi_{1/3}Mn_{1/3}CO_{1/3}O₂), while the problem of the thermal stability can be improved since manganese and oxygen are bonded relatively strongly, the basic and essential solution has not yet been attained. In the spinel type positive-electrode active material, strong bond between manganese and oxygen can be utilized and the thermal stability is superior to that of the layered metal oxide positive-electrode. However, the spinel type positive-electrode active material is inferior to other positive-electrodes in view of the electric capacity and the thermal degradability resistance.

In the olivine type compound LiFePO₄, it is known that oxygen is strongly bonded to phosphorus due to chemical covalent bond, and oxygen is less released by heat generation. FePO₄ as a charged phase of LiFePO₄ (Heterosite) is extremely stable against heating and, it does not release oxygen even when heated to 620° C. or higher but causes only the phase transfer to the quartz phase which is more stable in view of thermodynamics. In view of the above, it is considered that the covalent bond between phosphorus and oxygen is effective means for ensuring the thermal stability of the positive-electrode material. Accordingly, it is considered that a positive-electrode active material based on phosphoric acid is optimal as a candidate for new positive-electrode material in the feature that can provide high capacity and high safety.

The factor of realizing the high capacity is to be considered for the olivine type positive electrode active material LiFePO₄ which is typical as the phosphoric acid-based positive-electrode active material as an example. It is generally known that the olivine type LiFePO₄ only has an experimental electric capacity which is much lower than the theoretical capacity but the electric capacity increases by nanoparticulation of particles of the positive electrode active material thereby decreasing the particle size. The size of the fine particle necessary for the operation as the electrode is 200 nm or less. For attaining the theoretical capacity of 160 mAh/g in LiFePO₄, it is essential to particulate the positive-electrode active material further finely.

It is considered that the reason why the capacity increases by nanoparticulation concerns the moving distance of inserted lithium ions. When the particle size is large, the moving distance of the lithium ions in the particle of the positive-electrode active material is long. In such case, motions of the lithium ions may be hindered at a high possibility by various factors such as impurities in the particle, atom interchange defect (anti-site defect), ions trap by atomic vacancies, interruption of ion diffusion path attributable to the plane of unconformity such as a grain boundary, etc.

It is known that the diffusion path of lithium in LiFePO₄ is one dimensional. Such one dimensional diffusion path tends to undergo the effect of the crystal defects as described above (refer to Non-Patent Literature 3). That is, in the phosphoric acid compound of a one dimensional network form, since lithium ions move in the one dimensional manner through the network in the active material, it involves a drawback that the network is easily interrupted by the crystal defect. When one crystal defect such as an antisite defect is present in one lithium diffusion network, the utilization rate of the network (electric capacity) scarcely changes.

However, when two or more crystal defects are formed, a lithium-containing site between the defects in the one dimensional network can no more be utilized and the network utilization rate is lowered to decrease the electric capacity. The number of the one dimensional network having two or more defects increases abruptly as the size of fine particles increases. For example, even when only 0.1% antisite defect is assumed, a particle size of 100 nm is necessary for attaining 100% network utilization rate.

On the other hand, in the fine particle of 1 μm particle size, the theoretical value of the network utilization rate lowers as far as 50% to result in remarkable decrease in the electric capacity. In view of the above, for increasing the electric capacity, it is considered to be important that the dimension of the diffusion network for lithium ions is increased to more than 1.

It is anticipated that the dimension of the diffusion network of lithium ions in the pyrophosphoric acid positive-electrode active material Li₂MP₂O₇ is greater than 1 among the phosphoric acid compound positive-electrodes. In Li₂MP₂O₇, the lithium ions have a layered structure and have a layer-by-layer structure with a transition metal layer. When lithium ions move in a two dimensional manner within a layer, it can be said that this is a lithium ion diffusion network of higher than one dimension. In the Non-Patent Literature 2, since 1-electron theoretical capacity is attained relatively easily also for large size particles of about 1 μm without particle size control such as nanoparticulation, presence of a lithium diffusion network of a dimension different from that of the olivine type is anticipated.

If charge-discharge is possible for particles of large size with no requirement for particle size control, the fabrication process of nanoparticulation can be saved, restriction for the surface modification treatment is moderated greatly, thereby leading to lowering of the battery cost, facilitation of the process control, and elimination of the factor for hindering the performance. If the surface modification treatment by the conductive material such as graphite, which was essential in the olivinic positive-electrode material, is not necessary, various advantages such as easy fabrication of electrode bonding, etc. can be obtained in addition to the cost reduction and facilitation of the process as described above.

However, the electric capacity of Li₂MP₂O₇ remains at 220 mAh/g and this only about 1.4 times of increases compared with that of the olivinic positive-electrode. Such electric capacity is not sufficient as the rank of the positive-electrode active materials of lithium ion battery in the future. It is necessary to increase the number of lithium ions contained in the chemical formula. Even when the number of lithium ions per chemical formula is increased, the electric capacity cannot be increased if the number of M as the charge compensation center also increases. That is, for increasing the electric capacity, it is not only necessary that the lithium ion content is increased in the chemical formula, but also it is necessary that the chemical formula has a ratio exceeding 1:2 between the charge compensation centers M and the lithium ions.

With the background as described above, the conditions for the positive-electrode material satisfying the requirement for the safety and the electric capacity is that (1) it has a utilizable network of higher than one dimension which can be expected to attain good diffusivity lithium, (2) phosphoric acid of high thermal stability is used, and (3) it has such lithium that the ratio exceeding 1:2 between the charge compensation center M and the lithium ion. However, positive-electrode materials satisfying such conditions have not yet been found.

### CITATION LIST

### Patent Literature

Patent Literature 1: Japanese Unexamined Patent Application Publication No. 2010-232001

### Non-Patent Literature

Non-Patent Literature 1: J. Electrochem. Soc. 148, A224 (2001)

Non-Patent Literature 2: J. Am. Chem. Soc. 132, 13596 (2010)

Non-Patent Literature 3: Nano Letters 10, 4123 (2010)

### SUMMARY OF INVENTION

### Technical Problem

The present invention has been proposed for improving the existent problems described above and the object thereof is to provide a positive-electrode material for a non-aqueous electrolyte secondary battery having a lithium diffusion network structure of two or more dimension with high lithium capacity, containing phosphoric acid of high thermal stability, and having such lithium ions that the ratio between the charge compensation centers M and the lithium ions exceeds 1:2.

### Solution to Problem

The present inventors, et al. have studied on a crystal structure of a positive-electrode material for attaining the foregoing object and, as a result, have got an idea of a crystal structure of a positive-electrode material having high safety by designing diffusion path of lithium by two or more dimensional lithium ion diffusion network, ensuring high electric capacity by increasing the content of lithium in the chemical formula, and by adopting the phosphoric acid framework. Design for the crystal structure of the positive-electrode material is to be described specifically.

As the charge compensation center, when polyelectron reaction is intended, a transition metal M capable of forming polyvalent ionization is assumed. The transition metal element has a d orbital at an angular momentum l=1 as the electron orbital. The d orbital has five orbitals due to the degree of degeneracy 2l+1. Depending on whether electrons occupy or not occupy the orbital, the transition metal is oxidized or reduced and can be a charge compensation center in charge-discharge. The oxidation/reduction of the transition metal M used generally includes M³⁺/M⁴⁺ in the layered rock-salt type positive-electrode active material and M²⁺/M³⁺ in the olivine type positive-electrode active material in the olivinic positive-electrode active material. For corresponding to the deeply oxidized state M^{N+}(N>3) of the transition metal by multi-electron reaction, it is advantageous that the number of valance of M in the lithiated state is smaller. Accordingly, + bivalent transition metal ion M²⁺ is adopted as the charge compensation center. Even in the case of the transition metal ions, those that can hardly take a + bivalent or higher valent state cannot be adopted.

As the monovalent ion attributable to ion transport, there may be considered a member from the group consisting of elements Li, Na, K, Rb, Cs, and Fr belonging to alkali metals. All of the elements take an electron configuration where the s orbital is occupied by one electron and take a monovalent state by transferring electrons to an element of high electronegativity. Lithium ion is most preferred and sodium ion is preferred next thereto. Since ions of atomic numbers larger than those of a potassium ion have large ionic radius and heavy molecular weight, they are not preferred compared with lithium ions or sodium ions.

In view of the above, the chemical formula of the novel high capacity positive-electrode material is AₓM(PO₄)_{y}. A represents an alkali metal and M represents a transition metal. PO₄ represents phosphoric acid. Since a simple ratio is convenient for the design of the crystal structure, it is assumed that the number for M is 1, and x and y are integers respectively. Respective formal charges are +1 for A, +2 for M and −3 for PO₄. Since the conditional formula of (x, y) for satisfying the stoichiometrical compositional ratio in order to perform synthesis is x+2−3y=0, a set of integers (x, y) satisfying the same is a candidate for the novel high capacity positive-electrode material. (x, y)=(1, 1) is a case for the olivine type positive-electrode material in which the ratio between the number of the transition metal and the number of the alkali metal is 1:1 which cannot be said to have high capacity. Then, a set of (x, y) provides an integer in a case where (x, y)=(4, 2). Such positive-electrode materials have not yet been found and, since the ratio of the number between the number of transition metal and the number of the alkaline metal is 1:4, there is a possibility that a positive-electrode material having an electric capacity much higher than that of existent positive-electrode material can be provided. Accordingly, we define the chemical formula of the novel material for the high capacity positive-electrode material as A₄M(PO₄)₂.

For attaining a high capacity, it is necessary that the lithium ion has two or more dimensional diffusion network. The method of forming the same is to be described. A layered rock-salt structure which forms a secondary network takes an ABC stacking structure. This is because the layered rock-salt structure comprises only the MO₆ octahedral structure in which oxygen is coordinated by the number of six to the transition metal M. On the other hand, a structure containing a phosphoric acid framework in addition to the MO₆ octahedral structure generally takes an AB stacking structure. Phosphoric acid PO₄ takes a tetrahedral structure and the shape is different from the MO₆ octahedral structure. PO₄ and MO₆ are ions in which the polyhedral center is charged positively and face sharing contact less occurs between a tetrahedron and an octahedron where energy is increased due to large electrostatic repulsion. The stacking structure formed under the condition of corner sharing and side sharing contact is an AB stacking. Generally, when the phosphoric acid framework is introduced, the stacking row is defined to the AB stacking.

The olivinic LiFePO₄ positive-electrode active material has the phosphoric acid framework and takes an AB stacking. The lithium diffusion network is one dimensional with no contact to adjacent diffusion networks. This is because the lithium diffusion network is present in all of the layers, and one dimensional diffusion networks are present alternately.

For devising a lithium diffusion network of a dimension higher than one dimension, the present inventors have at first devised a dense two dimensional lithium diffusion network due to a simple crystal structure.

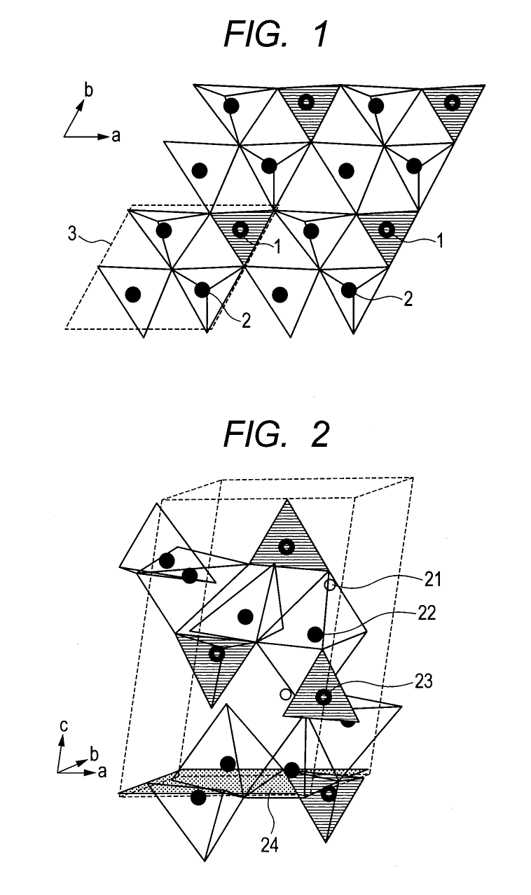

FIG. 1 shows the structure. A unit cell (or unitary cell) 3 is shown by a broken line, lithium 2 is shown by a black circle, and polyhedrons formed by oxygen atoms surrounding them (oxygen atom is arranged at each corner of the tetrahedron but not illustrated) is shown by a solid line, and phosphoric acid 1 is shown by a ring-like black circle. The distance between adjacent lithium atoms is about 3 Å and lithium can diffuse by hopping in a two dimensional manner. Since the diffusing distance of lithium is short and the path is two dimensional, high conductivity of lithium can be expected. Further, adjacent sites to which lithium is diffusible are present by the number of four in all of lithium sites showing that the degree of freedom for lithium diffusion is high. It is preferred that the number of adjacent sites is larger. In the olivine type phosphoric acid compound, the number of adjacent sites is 2. Further, the number of adjacent sites is 3 or 4 in Li₂MP₂O₇. The lithium diffusion network shown in FIG. 1 is different from any of lithium diffusion networks of the positive-electrode materials known so far.

Further, for realizing high diffusivity lithium by two or more dimensional lithium network, a one dimensional lithium wiring has been devised for connecting equivalent two dimensional diffusion networks of lithium. By the one dimensional lithium wiring, it can be expected that lithium moves between different lithium diffusion networks and increase in the amount of utilizing lithium can be expected. Further, by utilizing the one dimensional lithium wiring in addition to the two dimensional diffusion network, three dimensional diffusion of lithium can be expected. Accordingly, co-existence of two or more dimensional lithium diffusion network and the phosphoric acid framework can be realized in the invention.

4-electron reaction capable of utilizing four lithium atoms per one chemical formula Li₄M(PO₄)₂ can be expected. Since Li₄M(PO₄)₂ is 3.6×10⁻³ mol/g, the electric capacity can be anticipated theoretically. When all of lithium can be utilized for charge-discharge, the electric capacity is 390 mAh/g. The value is larger than the capacity of any of existent positive-electrode materials described above.

### Advantageous Effects of Invention

According to the present invention, a positive-electrode material having a phosphoric acid framework structure of high safety, two or more dimensional lithium diffusion network, and high electric capacity by 1 or more electron reaction can be provided.

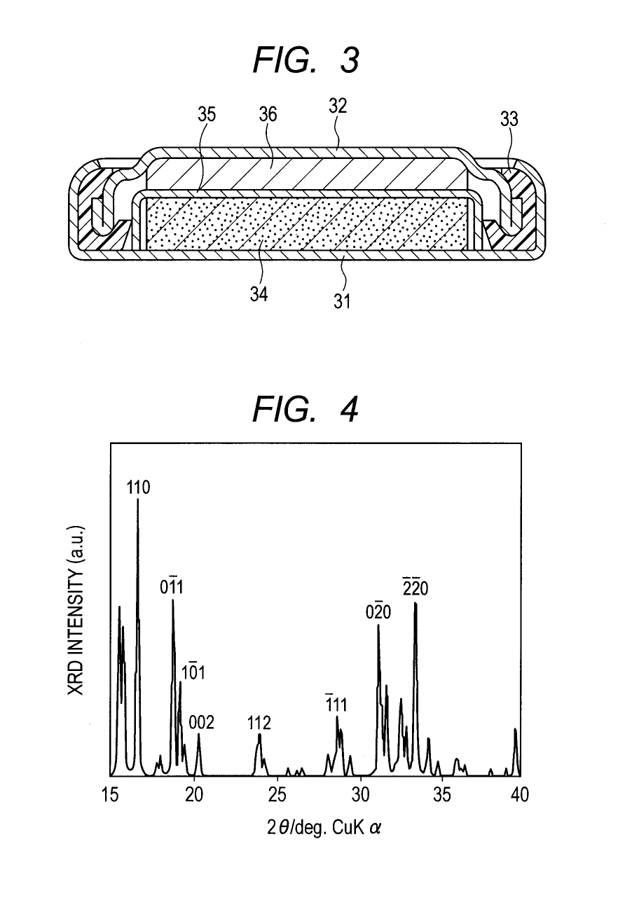

### BRIEF DESCRIPTION OF DRAWINGS

[FIG. 1] is a view showing a two dimensional lithium diffusion path of Li₄Fe(PO₄)₂ in ab plane.

[FIG. 2] is a view showing a crystal structure of Li₄Fe(PO₄)₂ according to the present invention.

[FIG. 3] is a cross sectional view of a coin type battery structure as an example of a preferred embodiment.

[FIG. 4] is a graph showing the result of evaluation for XRD peak intensity of a positive-electrode active material of a first embodiment.

### DESCRIPTION OF EMBODIMENTS

The compound as the positive-electrode active material of the invention can be manufactured by using known general methods and various methods can be adopted therefor. Specifically, in a case of Li₄Fe(PO₄)₂ for example, it is synthesized by mixing iron oxide Fe₂O₃ and a lithium phosphate compound and firing them in air. The lithium phosphate compound is one of members selected, for example, from the group consisting of Li₃PO₄, Li₄P₂O₇, and LiPO₃.

When a positive-electrode for a non-aqueous electrolyte secondary battery is manufactured by using the positive-electrode active material of the present invention, the active material may be used usually in a powdered form and an average particle size may be about 1 to 20 μm. The average particle size is a value measured, for example, by a laser diffraction particle size analyzer. Further, the content of the active material in the positive-electrode may be determined properly in accordance with the kind of the active material, the amounts of the binder and the conductive material to be used, etc. Further, in the manufacture of the positive-electrode, the active material described above may be used alone or as a mixture with other positive-electrode active materials known so far.

The positive-electrode of the invention may be manufactured in accordance with a known method of preparing the positive-electrode in addition to the use of the positive-electrode active material. For example, the powder of the active material may be mixed, in accordance with requirement, with a known binder (polytetrafluoriethylene, polyvinylidene fluoride, polyvinyl chloride, ethylenepropylenediene polymer, styrene butadiene rubber, acrylonitrile butadiene rubber, fluoro rubber, polyvinyl acetate, polymethyl methacrylate, polyethylene, nitrocellulose, etc.) and, further in accordance with requirement, with a known conductive material (such as acetylene black, carbon, graphite, natural graphite, artificial graphite, needle coke, carbon nanotube, carbon nanohorne, graphene nanosheet, etc.) and then the obtained powder mixture may be molded by press bonding on a support such as made of stainless steel or may be filled in a metal container. Alternatively, the electrode of the invention can be manufactured, for example, also by a method of coating a slurry obtained by mixing the powder mixture with an organic solvent (N-methylpyrrolidone, toluene, cyclohexane, dimethylformamide, dimethylacetamide, methyl ethyl ketone, methyl acetate, methyl acrylate, diethyltriamine, N-N-dimethylaminopropylamine, ethylene oxide, tetrahydrofuran, etc.) on a metal substrate such as made of aluminum, nickel, stainless steel, copper, etc.

The negative-electrode is formed by coating a negative-electrode mix to a collector made of copper or the like. The negative-electrode mix comprises, for example, an active material, a conductive material, a binder, etc. As the negative-electrode active material, metal lithium, carbon material, or material capable of inserting lithium or forming a compound thereof can be used, with the carbon material being particularly suitable. The carbon material includes graphites such as natural graphite and artificial graphite, and amorphous carbon such as coal coke, carbides of coal pitch, petroleum coke, carbide of petroleum pitch, and carbide of pitch coke. Preferably, the carbon materials described above applied with various surface treatments are used desirably. The carbon materials may be used not only alone but also two or more kinds of them may be used in combination. Further, the material capable of inserting lithium or forming a compound thereof includes metals such as aluminum, tin, silicon, indium, gallium, and magnesium, and alloys containing the elements, and metal oxides containing tin, silicon, etc. Furthermore, the material can include composite materials of the metal, alloy, or metal oxide described above with carbon material such as graphite or amorphous carbon.

FIG. 3 is a vertical cross sectional view of a coin type lithium secondary battery of a positional specific example of a battery according to the invention. In this embodiment, a battery having a size of 6.8 mm diameter and 2.1 mm thickness was manufactured. In FIG. 3, a positive-electrode casing 31 also serves as a positive-electrode terminal and comprises a stainless steel of excellent corrosion resistance. A negative-electrode casing 32 also serves as a negative-electrode terminal and comprises stainless steel, i.e., the same material as that for the positive-electrode casing 31. A gasket 33 insulates the positive-electrode casing 31 and the negative-electrode can 32 and is formed of polypropylene. A pitch is coated to the contact face between the positive-electrode can 31 and the gasket 33, and to the contact face between the negative-electrode 32 and the gasket 33. A separator 35 comprising a non-woven fabric formed of polypropylene is disposed between a positive-electrode molded body 34 and a negative-electrode molded body 36. When the separator 35 is disposed, an electrolyte is impregnated.

The shape of the secondary battery is not restricted to the coin type but may be practiced as a cylindrical shape formed by winding an electrode, for example, as 18650 type. Further, it may be practiced as a square shape by stacking electrodes.

### EXAMPLES

The present invention is to be described more specifically with reference to examples but the invention is not restricted to them. In the embodiments, batteries were manufactured and measured in a dry box within an argon atmosphere. The battery was started from a discharge process at the first cycle and then charge-discharge process was performed.

### Example 1

In this example, lithium carbonate, ammonium dihydrogen phosphate NH₄H₂PO₄ and iron oxide Fe₂O₃ were mixed at a predetermined molar ratio of 8:4:1 and then citric acid as a chelating agent was added and mixed. Then, the water content was evaporated while heating and stirring. After evaporation of the water content, remaining material was recovered as a precursor, and the precursor was subjected to a heat treatment in a firing atmosphere at 800° C. for 4 hours using an atmospheric furnace (argon gas stream), to manufacture Li₄Fe(PO₄)₂.

Instead of citric acid, other organic acids, for example, maleic acid, tartaric acid, succinic acid, etc. can be used. Further, the organic acid may be a mixture of a plurality of organic acids including citric acid, maleic acid, tartaric acid, succinic acid, etc.

The specimen after firing was pulverized for one hour by using a planetary ball mill (Planetary micro mill pulverizette 7 manufactured by FRITSCH Co.). Then, coarse particles of 50 μm or larger were removed by sieving. The resistivity was evaluated by weighing 1 g of sample and measuring by using a powder resistance evaluation device (Lorestar GP model manufactured by Mistubishi Chemical Corp.). The resistivity was measured under 40 MPa of load as oil pressure. The resistivity was 10 Ω·cm or lower and it can be seen that the electric conductivity is excellent.

X-ray diffraction profile was measured in a so-called 2θ/θ measurement by using an automatic X-ray diffraction apparatus (RINT-Ultima III manufactured by Rigaku Co.) using an X-ray source CuKα, at an output of 40 kV×40 mA. The result of measurement is shown in FIG. 4. Characteristic diffraction peaks were obtained and Li₄Fe(PO₄)₂ could be confirmed. In the drawing, blank circles represent iron ion 21, solid circles represent lithium ion 22, and ring-like solid circles represent phosphorus 23 respectively, and a region shown by dots represent a lithium diffusion layer 24.

### Example 2

In this example, lithium carbonate, Li₃PO₄, cobalt dioxide, and nickel oxide were used as the starting material for manufacturing a positive-electrode material, which were weighed so as to provide a ratio of Li:Co:Ni at 4.01:0.34:0.66, and they were wet pulverized and mixed in a pulverizer. After drying, the powder was placed in a high purity alumina container and fired temporarily in an atmospheric air at 600° C. for 12 hours for improving the sinterability. Then, it was again placed in the high purity alumina container and fired under the conditions in an atmospheric air at 950° C. for 12 hours, air cooled and then pulverized and classified. The obtained positive-electrode material was Li₄Co_{1/3}Ni_{2/3}(PO₄)₂. When the particle size distribution of the positive-electrode material was measured, the average particle size was 8 μm (average radius: 4 μm).

### Example 3

In this example, ion exchange simulation from lithium ions to sodium ions was performed by a quantum simulation technique based on the first principle calculation based on the crystal structure of Li₄CPO₄)₂ obtained in the first embodiment. Ion exchange was reproduced on a computer by substituting all lithium ions to sodium ions and optimization of the crystal structure was performed for Na₄M(PO₄)₂ by using generalized density gradient approximation considering the density functional theory and short range Hubbard correlation term. As a result of optimization for the crystal structure and the lattice length, Na₄M(PO₄)₂ having a crystal structure identical with that of Li₄CPO₄)₂ was obtained. The volume of the unit cell of Na₄M(PO₄)₂ was 287.7 Å³ and it was large by about 6% than Li₄(PO₄)₂. The result can be explained from the fact that the sodium ion has an ionic radius larger than that of the lithium ion and shows that Na₄(PO₄)₂ can be prepared experimentally.

### REFERENCE SIGNS LIST

1: phosphor
2: lithium ion
3: unit cell
21: iron ion
22: lithium ion
23: phosphorus
24: lithium diffusion layer
31: positive-electrode can
32: negative-electrode can
33: gasket
34: positive-electrode molded body
35: separator
36: negative-electrode molded body

1. A positive-electrode material for a secondary battery comprising a compound shown by a chemical formula of A₄₋ₓB(PO₄)₂ as a main ingredient in which
A is at least one element selected from alkali metals, B is at least one element selected from transition metals that can form bivalent or higher valent ions, and x is within a range of 0≦x≦4.

2. The positive-electrode material for a secondary battery according to claim 1, wherein
the transition metal B comprises a compound selected from at least one member of a group consisting of V, Cr, Mn, Fe, Co, Ni, Cu, Nb, Mo, and W.

3. The positive-electrode material for a secondary battery according to claim 1, wherein
the alkali metal A contains 3 or more other alkali metals within a radius of 4 Å.

4. The positive-electrode material for a secondary battery according to claim 1, comprising
a compound represented by Li₄₋ₓFe(PO₄)₂ in the chemical formula in which the alkali metal A is Li, and transition metal B is Fe.

5. The positive-electrode material in a secondary battery according to claim 1, comprising a compound represented by Li_{4—x}B(PO₄)₂ in the chemical formula in which the alkali metal A is Li and the transition metal B is at least one member selected from the group consisting of V, Cr, Mn, Co and Ni.

6. The positive-electrode material for a secondary battery according to claim 1, comprising a compound represented by Na₄₋ₓFe(PO₄)₂ in the chemical formula in which the alkali metal A is Na and the transition metal B is Fe.

7. A positive-electrode material for a secondary battery comprising A₄₋ₓB(PO₄)₂ of the chemical formula as a main ingredient, having a stacking structure where two dimensional layers containing A are stacked and having a diffusion network where A is diffusible in the two dimensional manner or one dimensional manner by adopting a structure of supporting the space between each of stacked layers by the phosphoric acid PO₄.

8. The positive-electrode material for a secondary battery according to claim 7, wherein
A is at least one element selected from alkali metals and B is at least one element selected from transition metals that can form bivalent or higher valent ions.

9. The positive-electrode material for a secondary battery according to claim 8, wherein
the alkali metal A is Li and x is 2 or more and 4 or less.

10. A secondary battery using the positive-electrode material according to claim 9.

11. A secondary battery using the positive-electrode material according to claim 1.

12. A secondary battery using the positive-electrode material according to claim 2.

13. A secondary battery using the positive-electrode material according to claim 3.

14. A secondary battery using the positive-electrode material according to claim 4.

15. A secondary battery using the positive-electrode material according to claim 5.

16. A secondary battery using the positive-electrode material according to claim 6.

17. A secondary battery using the positive-electrode material according to claim 7.

18. A secondary battery using the positive-electrode material according to claim 8.
